(19) United States
(12) Patent Application Publication
(10) Pub. No.: US 2011/0094121 A1
(43) Pub. Date: Apr. 28, 2011

(54) Universal clothes dryer system

(76) Inventor: Adam Whitley, Hot Springs Village, AR (US)

(21) Appl. No.: 12/924,853

(22) Filed: Oct. 7, 2010

Related U.S. Application Data
(63) Continuation-in-part of application No. 12/584,847, filed on Oct. 26, 2009.

(51) Int. Cl. F26B 25/06

(52) U.S. Cl. 34/201

(57) ABSTRACT

The Universal exhaust system provides a quick and easy way to prevent dryer lint from accumulating in the dryer.

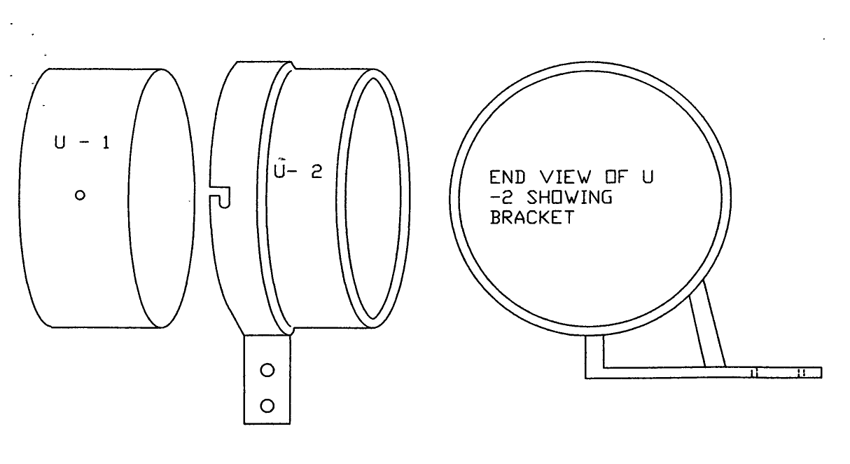

### BACKGROUND OF INVENTION

This invention deals exclusively with the unique method connecting the dryer to the exterior of the house. This system eliminates the problem and hassle of accessing the rear of the dryer to install the exhaust hose which in most cases result in the hose being too long resulting in a kinked or crushed hose when the dryer is placed in the operating position. A kinked or crushed hose causes heat buildup and increase the possibility of a home fire. The system also allows the quick and convenient method to disconnecting the dryer for easy vacuuming the accumulated lint.

### SUMMARY OF INVENTION

This invention is made of injection molded plastic and is simply a union of the exhaust hoses which makes installation quick and easy, eliminates kinking or crushing of the exhaust hoses preventing lint buildup. It takes seconds to disconnect allowing easy access to the rear of the dryer for vacuuming lint from the dryer proper.

The object of this system is to provide a quick and easy way to connect the clothes dryer hot air exhaust to a thru-wall fitting which eliminates the kinking or crushing of the flexible hose. The worker simply moves the dryer to a position where he/she has easy access to the rear of the dryer. He/she attaches a flexible hose to the dryer exhaust. The other end of this flexible hose is attached to smaller one half of a union. A flexible hose is attached to the house through-wall fitting. The other end of this flexible hose is attached to the larger half of the union.

The part of the union leading to the house thru-wall fitting has a bracket that is a part of the larger half of the union. This half of the union is screwed to the wall behind and level with the top of the dryer.

Without this product Installations are very difficult and time consuming they are also subject to kinking or crushing the exhaust hoses which in turn causes lint buildup and the possibility of a fire. Most installations make it very difficult to disconnect the dryer from the house thru-wall fitting for vacuuming lint from the dryer. In most cases the installer must climb over the dryer to access the rear for connecting the exhaust hose. One end of the hose is connected to the dryer exhaust; the other end is connected to the house exterior fitting usually resulting in a hose that is much too long which in most cases causes the hose to be kinked or crushed. Also there is no method for disconnecting the dryer for vacuuming excess lint.

### DETAILED DESCRIPTION OF THE INVENTION

There are two parts to the invention: which form a union when mated allows a smooth and uninterrupted flow of the exhaust air. When installed properly prevents the crushing or kinking of the hose.

Clothes dryers are usually located in a small utility room with insufficient room to remove the dryer for easy access for installing or disconnecting for lint removal.

I claim:

1. The universal clothes dryer system
I. Is easy to install
II. Eliminates crushing and kinking of the flexible hoses allowing a free flow of air from dryer to the exterior of the hose
III. Provides a quick and easy way to vacuum lint from dryer
